(19) United States
(12) Patent Application Publication
(10) Pub. No.: US 2019/0034916 A1
(43) Pub. Date: Jan. 31, 2019

(54) ELECTRONIC SYSTEM AND METHOD FOR MANAGING LOYALTY ACCOUNT IDENTIFIERS

(71) Applicant: Mastercard International Incorporated, Purchase, NY (US)

(72) Inventors: Gokul S K, Kollam (IN); Ajay Sinha, Pune (IN); Shivendra Dubey, Pune (IN)

(21) Appl. No.: 16/036,247

(22) Filed: Jul. 16, 2018

(30) Foreign Application Priority Data
Jul. 25, 2017 (SG) 10201706056T

(51) Int. Cl. G06Q 20/36; G06Q 20/34; G06Q 20/32; G06Q 30/02

(52) U.S. Cl. CPC G06Q 20/363; G06Q 30/0233; G06Q 20/322; G06Q 20/341

(57) ABSTRACT

The present disclosure generally relates to an electronic system, a computerized method, and a non-transitory computer-readable storage medium for managing loyalty account identifiers stored account identifiers stored in a payment device used in a transaction between a merchant and a consumer.

### CROSS-REFERENCE TO RELATED APPLICATION

This application is a U.S. National Stage filing under 35 U.S.C. § 119, based on and claiming benefits of and priority to Singapore Patent Application No. 10201706056T filed on Jul. 25, 2017. The entire disclosure of the above application is incorporated herein by reference for all purposes.

### TECHNICAL FIELD

The present disclosure generally relates to an electronic system and method for managing loyalty account identifiers. More particularly, the present disclosure describes various embodiments of an electronic system and method for managing loyalty account identifiers stored in a payment device used in a transaction between a merchant and a consumer.

### BACKGROUND

Merchants often try to encourage consumers to patronize them by offering attractive offers/promotions/discounts/incentives/benefits. One example is merchant loyalty programs which consumers can register or enrol for. In a typical merchant loyalty program, a customer or consumer enrols, registers, or otherwise signs up for a loyalty account with the merchant for participation in the loyalty program. The consumer is then provided with a physical loyalty or membership card which has a loyalty account identifier, e.g. consumer account number, associated with it. The loyalty card may have the loyalty account identifier printed on it, or may have it stored in a magnetic stripe of the card. In each transaction with the merchant, the consumer has to present the loyalty card to the merchant staff to accrue loyalty points, redeem loyalty points, or receive other benefits from the merchant.

A consumer who shops frequently at multiple merchants tends to accumulate these loyalty cards, each of them associated with one merchant. The consumer thus has to carry multiple loyalty cards in his/her wallet, in addition to the several other cards, e.g. identification and credit cards that the consumer already has in the wallet. As the consumer collects more of these loyalty cards, he/she may tend to lose track of them and the benefits of the merchant loyalty programs are diminished or rendered ineffective.

United States Patent Publication 2010/0106570 describes various systems and methods for enrolment and participation in a loyalty program. Particularly, a consumer has a payment card that contains loyalty program enrolment information (loyalty account identifier) and a payment card identifier. The storing of a new loyalty account identifier on the payment card as well as accrual of loyalty points requires appending the loyalty account identifier to usual transaction data. The transaction data appended with the loyalty account identifier is communicated to a payment network and in turn communicated to an issuer bank of the payment card. Accordingly, all loyalty-related transactions have to be performed via the issuer bank. There is less efficiency in the entire transaction process as the issuer bank has to be involved in every loyalty transaction, e.g. accrual/redemption of loyalty points, between the merchant and the consumer.

Therefore, in order to address or alleviate at least one of the aforementioned problems and/or disadvantages, there is a need to provide an electronic system and method for managing loyalty account identifiers, in which there is at least one improved feature over the aforementioned prior art.

### SUMMARY

According to a first aspect of the present disclosure, there is an electronic system, a computerized method, and a non-transitory computer-readable storage medium for managing loyalty account identifiers stored in a payment device used in a transaction between a merchant and a consumer. The system comprises a server operated by the merchant; a merchant terminal communicatively linked to the server; and a merchant database communicatively linked to the server, the merchant loyalty database comprising a number of loyalty accounts. The server is configured for performing steps of the method, comprising: receiving, from the payment device and via the merchant terminal, payment instrument data stored in the payment device; generating transaction data for communication to a payment network, the transaction data comprising the payment instrument data and a transaction cost; accessing loyalty account data stored in the payment device, the loyalty account data comprising a number of loyalty account identifiers; searching the loyalty account data for a loyalty account identifier associated with the merchant; and identifying, from the merchant database, a loyalty account associated with the loyalty account identifier responsive to the loyalty account identifier being found in the loyalty account data.

According to a second aspect of the present disclosure, there is a consumer payment card for managing loyalty account identifiers when used in a transaction with a merchant, the payment card comprising a chip device. The chip device is configured for storing: payment instrument data for communication to the merchant to generate transaction data and process the transaction; and loyalty account data for access by the merchant, the loyalty account data comprising a number of loyalty account identifiers, wherein the loyalty account data is accessible by the merchant for searching a loyalty account identifier associated with the merchant; wherein a loyalty account of the consumer associated with the loyalty account identifier is identified by the merchant responsive to the loyalty account identifier being found in the loyalty account data; and wherein a new loyalty account identifier is added to the loyalty account data responsive the loyalty account identifier not being found in the loyalty account data.

An advantage of the present disclosure is that the consumer can store and manage loyalty account identifiers in the payment device. The merchant terminal can read the loyalty account data and identify a loyalty account identifier associated with a loyalty account in the merchant database. If the loyalty account data does not have a loyalty account identifier associated with the merchant, the merchant may, upon the consumer's request, to add a new loyalty account identifier to the loyalty account data. As multiple loyalty account identifiers can be stored in a single payment device, the consumer does not need to carry multiple loyalty cards in his/her wallet, reducing the bulkiness of the wallet.

An electronic system and method for managing loyalty account identifiers according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an electronic system for managing loyalty account identifiers, in accordance with embodiments of the present disclosure.

FIG. 2 is a general flowchart illustration of a computerized method for managing loyalty account identifiers, in accordance with embodiments of the present disclosure.

FIG. 3A is an illustration of a payment device for managing loyalty account identifiers, in accordance with an embodiment of the present disclosure.

FIG. 3B is an illustration of a payment device for managing loyalty account identifiers, in accordance with another embodiment of the present disclosure.

FIG. 4 is a detailed flowchart illustration of a computerized method for managing loyalty account identifiers, in accordance with an embodiment of the present disclosure.

FIG. 5 is a detailed flowchart illustration of a computerized method for managing loyalty account identifiers, in accordance with another embodiment of the present disclosure.

FIG. 6 is a block diagram illustration of the technical architecture of a server of the electronic system of FIG. 1, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. For purposes of brevity and clarity, descriptions of embodiments of the present disclosure are directed to an electronic system and method for managing loyalty account identifiers, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

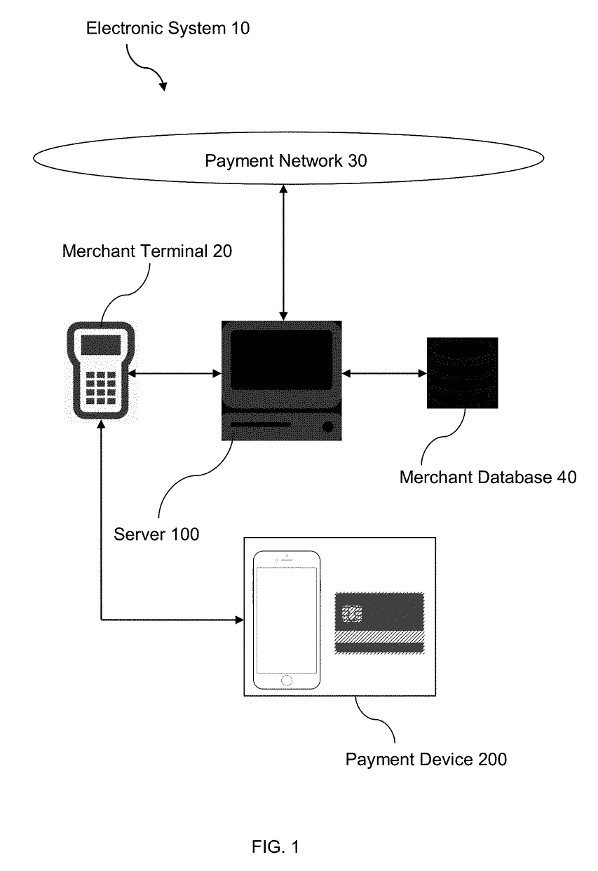

In representative or exemplary embodiments of the present disclosure, there is provided an electronic system 10 as illustrated in FIG. 1. The system 10 includes a server 100 having a processor and a data storage device or memory configured to store computer-readable instructions. The server 100 is operative by a merchant (or in some instances via an agent/agency for the merchant) for managing loyalty account identifiers in transactions between the merchant and customers/consumers. The system 10 further includes a merchant terminal 20, also known as merchant billing machine, payment terminal, or point-of-sale (POS) terminal. The merchant terminal 20 is an electronic device or machine that enables the merchant to perform transactions with the consumers. The merchant terminal 20 is located at the retail premises of the merchant where the consumers patronize, and is communicatively linked or connected to the server 100. The server 100 may be located also at the merchant retail premises or alternatively at a remote location, such as a centralized location for controlling operations of several retail branches of the merchant.

The system 10 further includes a payment network 30 that may be operated by an organization such as a payment card or credit card association, e.g. MasterCard® or Visa®. The server 100 is communicatively linked to the payment network 30, or it may alternatively be interpreted that the server 100 is communicatively linked such that it forms part of, is integrally connected, or operative within the payment network 30. The payment network 30 additionally connects or links together multiple financial institutions, particularly issuer banks and acquirer banks for processing transactions between merchants and consumers. It will be appreciated that the processing of transactions in the payment network 30 is performed in a standard manner and would be readily understood by the skilled person.

Consumers patronize the merchant retail premises to transact with the merchant for purchasing of products. In a typical transaction, a consumer uses a payment device 200 to perform the transaction and pay for the products. The payment device 200 is, includes, or is linked to a payment instrument or payment vehicle of the consumer. The term “payment instrument” may refer to any suitable cashless payment mode or mechanism, such as payment cards. Payment cards may include credit cards, debit cards, prepaid cards, and/or charge cards which the customer uses to pay for transactions. In addition to payment cards, payment instruments may include, but are not limited to, membership cards, promotional cards, frequent flyer cards, identification cards, gift cards, and/or any other payment cards that may hold payment card information and which may be stored electronically.

The merchant operates a loyalty program which consumers may opt to participate in. Consumers or participants of this loyalty program have loyalty accounts enrolled or registered with the merchant. The loyalty accounts store consumer personal data as well as loyalty data, depending on the type of loyalty program operated by the merchant. For example, the loyalty accounts contain the loyalty points the consumers have accrued from past purchase transactions and which are available for redemption.

The system 10 additionally includes a merchant database 40 communicatively linked to the server 100 for recording and maintaining loyalty data of the consumers. Accordingly, the merchant database 40 includes or contains a number of loyalty accounts, each loyalty account being associated with a consumer. The merchant database 40 may reside locally on the server 100, or alternatively on a remote server or computer communicatively linked to the server 100.

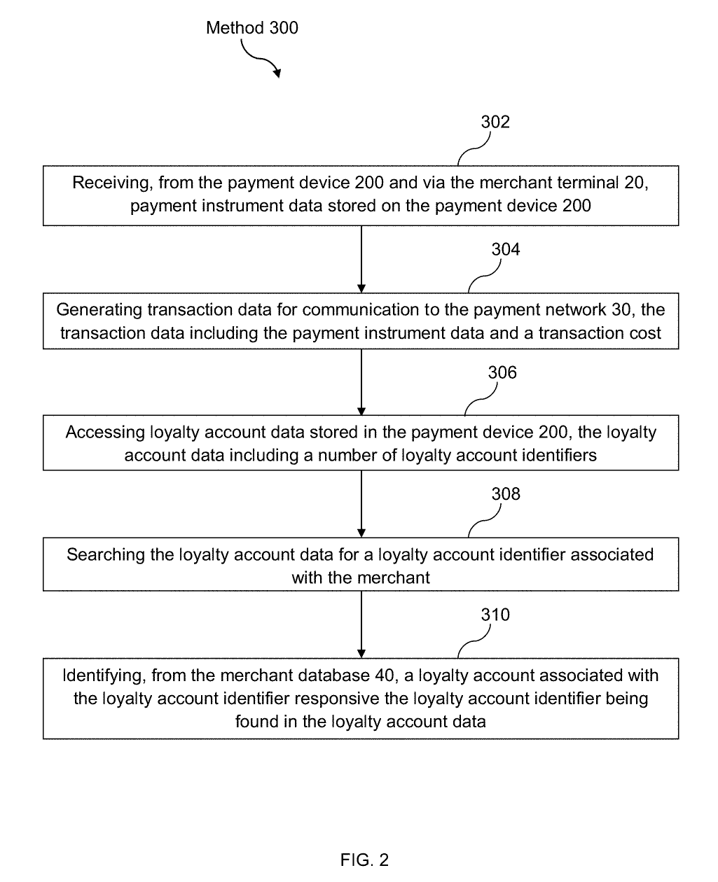

In various embodiments with reference to FIG. 2, there is shown a computer-implemented or computerized method 300, i.e. implemented on a computer or computer system such as or including the server 100, for managing loyalty account identifiers stored in the payment device 200 used in a transaction between a merchant and a consumer. The method 300 broadly includes:
a. a step 302 of receiving, from the payment device 200 and via the merchant terminal 20, payment instrument data stored in the payment device 200;
b. a step 304 of generating transaction data for communication to the payment network 30, the transaction data including the payment instrument data and a transaction cost;
c. a step 306 of accessing loyalty account data stored in the payment device 200, the loyalty account data including a number of loyalty account identifiers;
d. a step 308 of searching the loyalty account data for a loyalty account identifier associated with the merchant; and
e. a step 310 of identifying, from the merchant database 40, a loyalty account associated with the loyalty account identifier responsive to the loyalty account identifier being found in the loyalty account data.

The payment device 200 stores the payment instrument data for communication to the merchant for generating the transaction data and subsequent communication to the payment network 30 to process the transaction. The payment device 200 further stores the loyalty account data for access by the merchant.

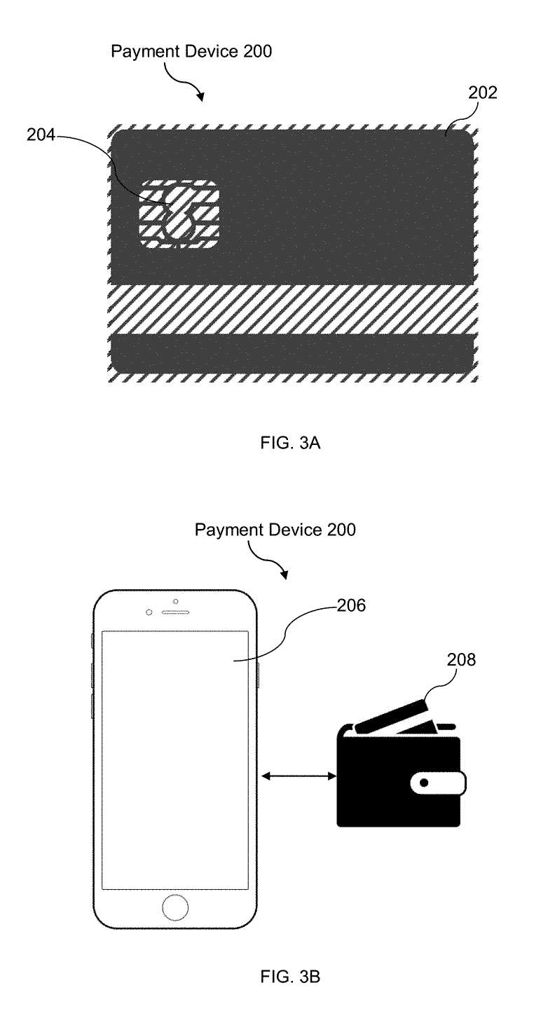

In one embodiment with reference to FIG. 3A, the payment device 200 is a payment card 202 such as a credit card or debit card. The payment card 202 represents the payment instrument of the consumer and includes or is coupled to a chip device 204 for storing the payment instrument data and loyalty account data. The chip device 204 is an integrated circuit and may also be referred to as an EMV® (Europay, MasterCard®, Visa®) chip. EMV is a technical standard for smart payment cards 202 and for merchant terminals 20 that can accept them. The merchant terminal 20 reads the payment card 202 upon insertion of the payment card 202 into the merchant terminal 20, i.e. via contact communication. Specifically, the merchant terminal 20 reads and accesses the data stored in the chip device 204. Alternatively, the merchant terminal 20 reads the payment card 202 by contactless communication, such as near field communications (NFC). Accordingly, the chip device 204 is NFC-compliant and the payment card 202 is NFC-enabled.

The chip device 204 may have limited storage capacity and may contain only a minimal number of data elements. The payment instrument data stored in the chip device 204 includes a payment instrument identifier, e.g. credit card number. The payment instrument data may further include authentication data for authorizing payments by the payment instrument, such as a security code and a personal identification number (PIN). The loyalty account data stored in the chip device 204 includes a number of loyalty account identifiers, each of which is associated with a merchant and represents a merchant loyalty program the consumer has enrolled in. Each loyalty account identifier may be in the form of an alphanumeric string, such as “XXX-YYY”, wherein “XXX” represents the merchant identity and “YYY” represents an identifier of the consumer's loyalty account with this merchant. Examples include “SAFEWAY-123456”, “SEARS-123457”, and “MACYS-123458”.

In another embodiment with reference to FIG. 3B, the payment device 200 is an electronic device 206. The electronic device 206 may be a mobile device such as a mobile phone, smartphone, personal digital assistant (PDA), tablets, laptop, or computer. In this embodiment, the electronic device 206 is a mobile phone or smartphone that is linked to one or more payment instruments 208, such that the electronic device 206 is configured and operative as a digital wallet and allows the consumer to perform transactions with merchants. The digital wallet may be operated on a software or digital wallet application executable on the electronic device 206, such that the electronic device 206 is configured to execute the digital wallet application with the payment instrument data. An example of a digital wallet is MasterPass® by MasterCard®. Details of the payment instruments 208 may be stored locally on the electronic device 206 or retrieved remotely with the electronic device 206.

The consumer uses the electronic device 206 to communicate with the merchant terminal 20 and pay for transactions with the merchants, specifically with a selected one of the payment instruments 208 linked to the digital wallet. Notably, the merchant terminal 20 may be configured to accept digital wallets. Communication between the electronic device 206 and merchant terminal 20 may occur wirelessly or contactless, such as via NFC protocol. The electronic device 206 includes a storage device for storing the payment instrument data and loyalty account data. As the storage device has a larger storage capacity than an EMV chip device 204, more details associated with the payment instruments 208 and loyalty account data may be stored in the electronic device 206. These additional details may include authentication data for the payment instruments 208, transaction records associated with the loyalty account, and current status of the loyalty account, e.g. available loyalty points for redemption.

The electronic device 206 may further include a SIM (subscriber identity module) card or a Secure Element with EMV functionality. This SIM card or Secure Element functions in a similar manner as the EMV chip device 204 described above with reference to FIG. 3A.

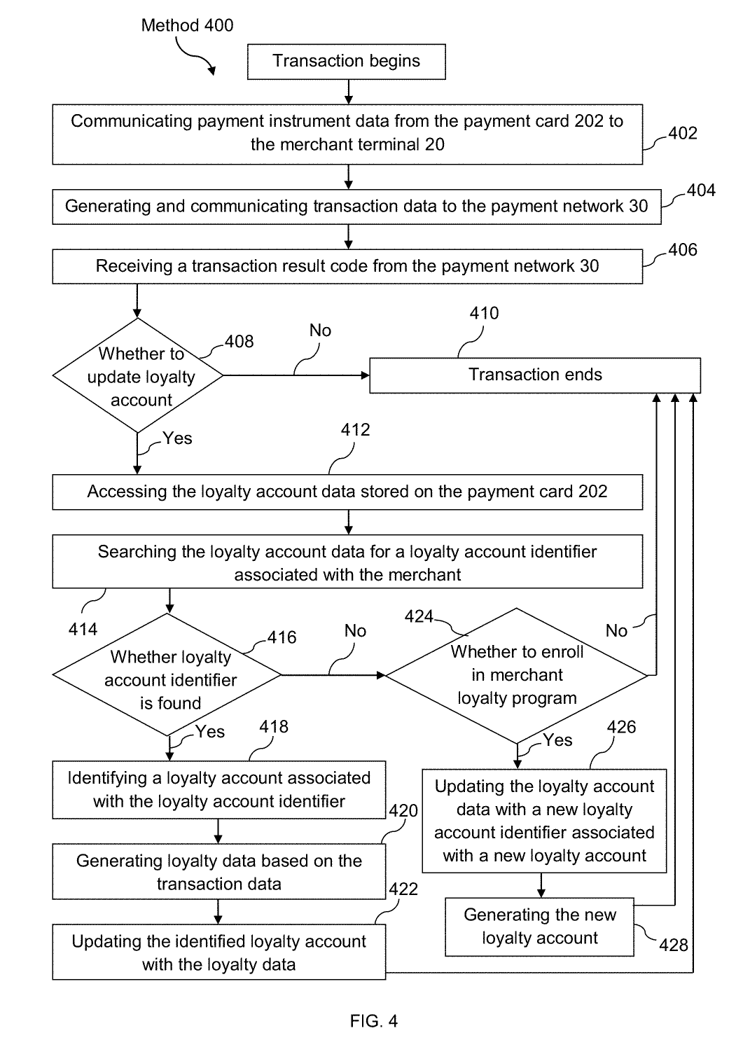

In some embodiments, the consumer uses a payment device 200 in the form of a payment card 202 for transacting with the merchant. One embodiment of the method 300 is illustrated as a method 400 for managing loyalty account identifiers with reference to FIG. 4. More specifically, the method 400 relates to managing loyalty data in a loyalty account associated with an identified loyalty account identifier when a consumer earns/accrues/accumulates loyalty points/stamps in a transaction with a merchant.

In the method 400, the consumer firstly initiates the transaction, e.g. for purchase of products, with the merchant. In a step 402, payment instrument data is communicated from the payment card 202 of the consumer to the merchant terminal 20, and is subsequently communicated to the server 100. In a step 404, the server 100 generates and communicates transaction data to the payment network 30, the transaction data including the payment instrument data and a transaction cost, i.e. the cost of the products purchased by the consumer. The payment network 30 receives the transaction data and processes the transaction in a standard manner. In a step 406, a transaction result code is communicated from the payment network 30 to the server 100, indicating that the transaction is successfully completed.

In a step 408, the merchant asks the consumer whether he/she wishes to update his/her loyalty account with loyalty data derived based on the transaction data, specifically for accrual or accumulation of loyalty points/stamps. If the consumer opts out, the transaction ends in a step 410. If the consumer decides to update the loyalty account, the merchant then, in a step 412, accesses the loyalty account data stored in the payment card 202. Alternatively, the merchant may automatically access the loyalty account data in response to successful completion of the transaction. The loyalty account data may be stored in a loyalty applet on the chip device 204 of the payment card 202. The loyalty applet is identified based on records referenced by a PSE (payment system environment) applet on the chip device 204. The PSE applet contains the payment instrument data and credentials for processing payments from the payment instrument. By reading the records referenced by the PSE applet, the merchant is able to identify various applets stored in the chip device 204, including the loyalty applet. In the step 412, the merchant, specifically the server 100 which is communicative with the chip device 204 via the merchant terminal 20, selects and accesses the loyalty applet. The various applets on the chip device 204 are preloaded by the manufacturer of the payment card 202 and may be encrypted to prevent data theft.

In a step 414, the server 100 searches the loyalty account data for a loyalty account identifier associated with the merchant. As the loyalty account data contains a number of loyalty account identifiers associated with various merchants depending on the number of loyalty programs that the consumer has enrolled in, there may be one loyalty account identifier that is associated with the merchant which the consumer has just completed the transaction with. Various known search algorithms may be used to search the loyalty account data. For example, the search may include finding an identifier of the merchant name, e.g. “SAFEWAY”, “SEARS”, or “MACYS”, within the alphanumeric strings of the loyalty account identifiers.

The method 400 includes a step 416 of determining whether the loyalty account identifier associated with the merchant is found in the loyalty account data based on the search results. If the loyalty account identifier is found, the step 416 proceeds to a step 418 of identifying, from the merchant database 40, a loyalty account associated with the loyalty account identifier found from the search results. In a subsequent step 420, the server 100 generates loyalty data based on the transaction data.

In one example, the merchant has a loyalty program that allows the consumer to accrue or accumulate loyalty points based on the amount he/she spends at the merchant. If the transaction cost for the purchased products is $100, the consumer may earn or accrue 100 loyalty points. The rate of loyalty points earned per dollar spent may be predetermined by the merchant. The loyalty points may be used for redemption of benefits from the merchant, such as discounts or gifts. The loyalty data thus relates to accruing loyalty points on the identified loyalty account, wherein the loyalty points are calculated based on the transaction cost.

In another example, the merchant has a loyalty program that allows the consumer to accrue loyalty stamps based on spending brackets in the transaction cost. The consumer may earn 1 loyalty stamp for every $10 spent at the merchant. The loyalty stamps may be used for redemption of benefits from the merchant, such as discounts or gifts. More stamps would allow the consumer to redeem a higher-valued discount or gift. The loyalty data thus relates to accruing loyalty stamps on the identified loyalty account, wherein the loyalty stamps are calculated based on the transaction cost.

After generating the loyalty data, in a subsequent step 422, the server 100 updates the identified loyalty account with the loyalty data. Specifically, the calculated loyalty points/stamps are added into the consumer's loyalty account on the merchant database 40. The transaction then ends in the step 410.

Conversely for the step 416, if the loyalty account identifier is not found in the loyalty account data based on the search results from the step 414, this would mean that the consumer does not have a loyalty account with the merchant and would not be able to accrue any loyalty points/stamps. In a step 424, the merchant asks the consumer whether he/she wishes to enroll into the merchant loyalty program and register a new loyalty account. If the consumer opts out, the transaction ends in the step 410. If the consumer decides to register the new loyalty account, the merchant then, in a step 426, updates the loyalty account data with a new loyalty account identifier associated with the new loyalty account. As the payment card 202 is still in communication with the merchant terminal 20, the server 100 in a step 428 generates the new loyalty account. The new loyalty account stored in the merchant database 40 is also updated with the accrued loyalty points/stamps. The transaction then ends in the step 410. The consumer now has the loyalty account identifier stored in the payment card 202 and would be able to accrue additional loyalty points/stamps in future transactions with the merchant.

Alternatively, if the consumer already has an existing loyalty account with the merchant but the loyalty account identifier is not yet added into the payment card 202, the consumer may inform the merchant staff to update the loyalty account data with a new or existing loyalty account identifier associated with the existing loyalty account. The existing loyalty account is updated accordingly with the accrued loyalty points/stamps.

The transaction between the merchant and the consumer thus includes a transaction data portion which occurs between the server 100 and the payment network 30, as well as a loyalty data portion which occurs between the server 100 and the payment card 202. Furthermore, the loyalty data portion occurs after the transaction data portion has been successfully completed, i.e. payment has been received by the merchant from the consumer's payment instrument.

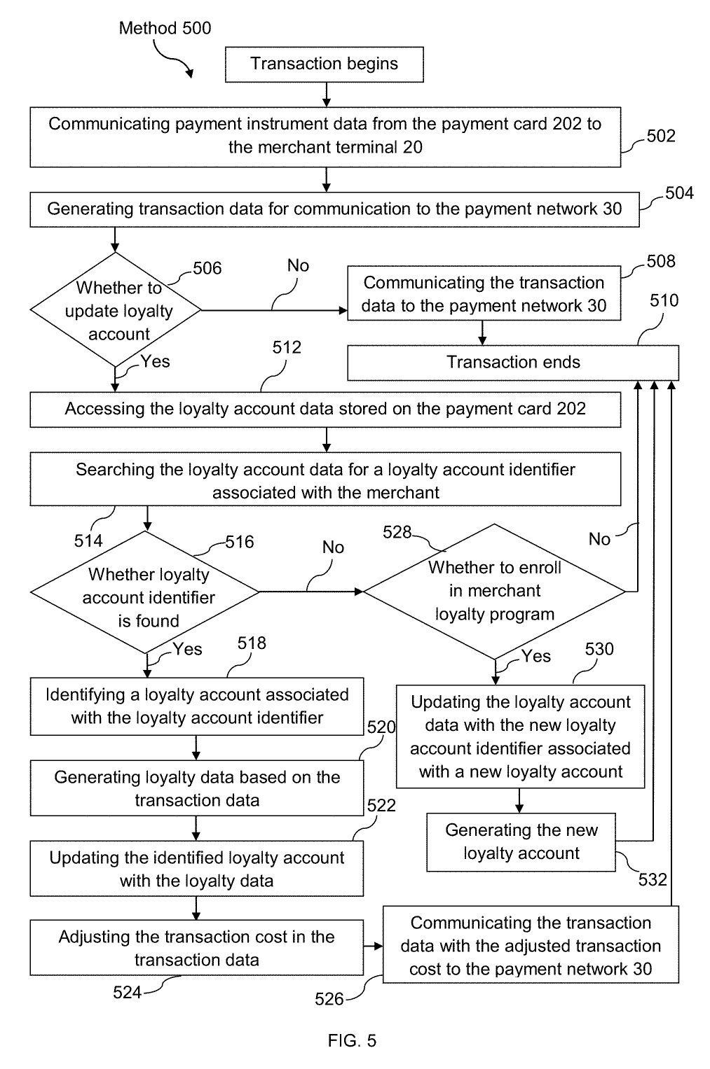

In another embodiment of the method 300, there is a method 500 for managing loyalty account identifiers as illustrated in FIG. 5. More specifically, the method 500 relates to managing loyalty data in a loyalty account associated with an identified loyalty account identifier when a consumer redeems or uses loyalty points in a transaction with a merchant. For purpose of brevity, various aspects of the method 500 are analogous to that of the method 400 and are omitted in the following description of the method 500.

In the method 500, the consumer firstly initiates the transaction with the merchant. In a step 502, payment instrument data is communicated from the payment card 202 of the consumer to the merchant terminal 20, and is subsequently communicated to the server 100. In a step 504, the server 100 generates transaction data for communication to the payment network 30, the transaction data including the payment instrument data and a transaction cost.

In a step 506, the merchant asks the consumer whether he/she wishes to update his/her loyalty account with loyalty data derived based on the transaction data, specifically for redemption of loyalty points/stamps. If the consumer opts out, the step 506 proceeds to a step 508 wherein the server 100 communicates the transaction data to the payment network 30. The payment network 30 receives the transaction data and processes the transaction in a standard manner. The transaction then ends in a step 510 without any update to the loyalty account. Conversely, if the consumer decides to update the loyalty account, the merchant then, in a step 512, accesses the loyalty account data stored in the payment card 202. In the step 512, the server 100 selects and accesses the loyalty applet stored in the chip device 204 of the payment card 202.

In a step 514, the server 100 searches the loyalty account data for a loyalty account identifier associated with the merchant. The method 500 includes a step 516 of determining whether the loyalty account identifier associated with the merchant is found in the loyalty account data based on the search results. If the loyalty account identifier is found, the step 516 proceeds to a step 518 of identifying, from the merchant database 40, a loyalty account associated with the loyalty account identifier found from the search results. In a subsequent step 520, the server 100 generates loyalty data based on the transaction data.

The merchant may have a loyalty program that allows the consumer to redeem accrued/accumulated loyalty points/stamps. The loyalty points/stamps may be used for redemption of benefits from the merchant, such as discounts or gifts. The number of loyalty points/stamps required per dollar of discount may be predetermined by the merchant. If the transaction cost for the purchased products is $100, the consumer may redeem 100 loyalty points or 10 stamps for a $10 discount. The loyalty data thus relates to redeeming loyalty points/stamps from the identified loyalty account.

After generating the loyalty data, in a subsequent step 522, the server 100 updates the identified loyalty account with the loyalty data. Specifically, the calculated loyalty points/stamps are redeemed and the redeemed loyalty points/stamps are deducted from the consumer's loyalty account on the merchant database 40. In a step 524, the transaction cost in the transaction data is adjusted based on the redeemed loyalty points/stamps. For example, if 100 loyalty points/10 loyalty stamps are redeemed for a $10 discount, the transaction cost is adjusted from $100 to $90.

In a step 526, the server 100 updates and communicates transaction data to the payment network 30, the transaction data including the payment instrument data and the adjusted transaction cost. The payment network 30 receives the transaction data and processes the transaction in a standard manner. The transaction then ends in the step 510.

Conversely for the step 516, if the loyalty account identifier is not found in the loyalty account data based on the search results from the step 514, this would mean that the consumer does not have a loyalty account with the merchant and would not be able to redeem any loyalty points/stamps. In a step 528, the merchant asks the consumer whether he/she wishes to enroll into the merchant loyalty program and register a new loyalty account. If the consumer opts out, the transaction ends in the step 510. If the consumer decides to register the new loyalty account, the merchant then, in a step 530, updates the loyalty account data with a new loyalty account identifier associated with the new loyalty account. In a step 532, the server 100 generates the new loyalty account stored in the merchant database 40. The transaction then ends in the step 510.

In the method 500 described above, the transaction data is firstly generated in the step 504 and includes the payment instrument data and unadjusted transaction cost. The transaction data is later updated in the step 526 to reflect the adjusted transaction cost in view of the loyalty points/stamps redemption. In one variation of the method 500, the step 504 may be omitted such that the transaction data is generated after the loyalty points/stamps redemption, the transaction data including the adjusted transaction cost.

The transaction between the merchant and the consumer thus includes a transaction data portion which occurs between the server 100 and the payment network 30, as well as a loyalty data portion which occurs between the server 100 and the payment card 202. Furthermore, the loyalty data portion occurs before the transaction data portion as the loyalty data portion relates to redemption of loyalty points/stamps and the transaction data is updated according to the redemption. Alternatively, the consumer may redeem the loyalty points/stamps for free items, without performing any transaction with the merchant.

While the methods 400 and 500 described above relate to the payment device 200 being a payment card 202 with an EMV chip device 204, various aspects of the methods 400 and 500 apply analogously to other embodiments wherein the payment device 200 is an electronic device 206 configured as a digital wallet or configured to execute a digital wallet application with the payment instrument data.

In some embodiments, the payment network 30 may require the consumer to provide authentication data in order to transfer payment from the consumer's payment instrument to the merchant. The authentication data may be in the form of a PIN, signature, and/or biometrics such as fingerprints. Furthermore, the merchant may authenticate the payment instrument during the transaction. For example. The payment device 200 may store authentication data in an encrypted format, such as a PIN stored in the EMV chip device 204 of a payment card 202. When the payment card 202 is in communication with the merchant terminal 40, the payment instrument data and authentication data is communicated from the payment card 202 to the merchant terminal 40. The consumer then inputs the PIN and the PIN is verified against the authentication data.

Embodiments of the present disclosure described above relate to an electronic system 10 and computerized method 300 for managing loyalty account identifies stored in a payment device 200 used in a transaction between a merchant and a consumer. Particularly, the payment device 200, such as a payment card 202 or electronic device 206 configured as a digital wallet configured to execute a digital wallet application, stores loyalty account data thereon. The loyalty account data includes a number of identifiers of loyalty accounts which the consumer has enrolled in with various merchant loyalty programs. During the transaction, the consumer provides the payment device 200 for making payment. In addition, as the payment device 200 stores the loyalty account identifiers, the merchant can identify the corresponding loyalty account on the merchant database 40 and update it with loyalty data generated based on the transaction data. Accordingly, the consumer can automatically earn loyalty points/stamps on his/her loyalty account. Likewise, the consumer can provide the payment device 200 to redeem loyalty points/stamps from his/her loyalty account. If the loyalty account data does not have a loyalty account identifier associated with the merchant, the merchant may, upon the consumer's request, to add a new loyalty account identifier to the loyalty account data.

Thus, loyalty account identifiers can be stored and managed in the payment device 200, and the consumer only needs to provide the payment device 200 to the merchant. The server 100 automatically retrieves the loyalty account identifier and updates the corresponding loyalty account on the merchant database 40. As multiple loyalty account identifiers can be stored in a single payment device 200, the consumer does not need to carry multiple loyalty cards in his/her wallet, reducing the bulkiness of the wallet.

As described above, the transaction involves a transaction data portion and a loyalty data portion. The transaction data is communicated to the payment network 30 which links together issuer banks and acquirer banks for processing payment from the consumer's payment instrument to the merchant. However, the loyalty data portion is performed among the server 100, merchant terminal 20, and payment device 200, without involving the payment network 30. This leads to greater efficiency in updating loyalty accounts in the merchant database 40 as the issuer banks and acquirer banks are not involved in the accrual and redemption of loyalty points/stamps.

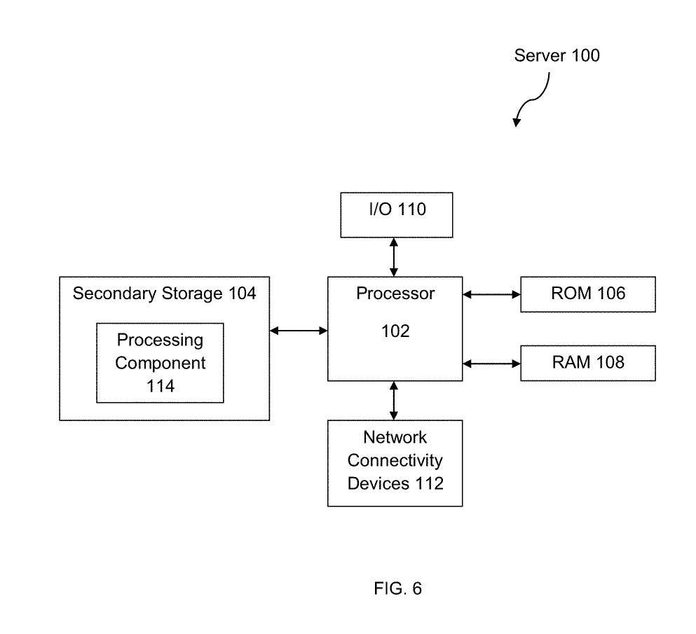

The following is a description of the technical architecture of the server 100 with reference to FIG. 6.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to an electronic system and method for managing loyalty account identifiers are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for managing loyalty account identifiers stored in a payment device used in a transaction between a merchant and a consumer, the system comprising:
a server operated by the merchant;
a merchant terminal communicatively linked to the server; and
a merchant database communicatively linked to the server, the merchant loyalty database comprising a number of loyalty accounts,
wherein the server is configured for performing steps comprising:
receiving, from the payment device and via the merchant terminal, payment instrument data stored in the payment device;
generating transaction data for communication to a payment network, the transaction data comprising the payment instrument data and a transaction cost;
accessing loyalty account data stored in the payment device, the loyalty account data comprising a number of loyalty account identifiers;
searching the loyalty account data for a loyalty account identifier associated with the merchant; and
identifying, from the merchant database, a loyalty account associated with the loyalty account identifier responsive to the loyalty account identifier being found in the loyalty account data.

2. The system according to claim 1, wherein the server is further configured to generate loyalty data based on the transaction data for updating the identified loyalty account.

3. The system according to claim 1, wherein the server is further configured to update the loyalty account data with a new loyalty account identifier if the loyalty account identifier is not found in the loyalty data.

4. The system according to claim 3, wherein the server is further configured to generate a new loyalty account associated with the new loyalty account identifier.

5. The system according to claim 1, wherein the payment device is a payment card comprising a chip device for storing the payment instrument data and loyalty account data.

6. The system according to claim 1, wherein the payment device is a mobile device configured to execute a digital wallet application with the payment instrument data.

7. The system according to claim 2, wherein the server is further configured to update the identified loyalty account with the loyalty data in response to successful completion of the transaction by the payment network.

8. The system according to claim 7, wherein the server is configured to update the identified loyalty account with the loyalty data by accruing loyalty points on the identified loyalty account, the loyalty points being calculated based on the transaction cost.

9. The system according to claim 2, wherein the server is further configured to update the identified loyalty account with the loyalty data by deducting redeemed loyalty points from the identified loyalty account.

10. The system according to claim 9, wherein the server is further configured to adjust the transaction cost in the transaction data based on the redeemed loyalty points.

11. The system according to claim 10, wherein the server is further configured to communicate the transaction data with the adjusted transaction cost to the payment network for processing the transaction.

12. A computerized method implemented on a server for managing loyalty account identifiers stored in a payment device used in a transaction between a merchant and a consumer, the method comprising steps of:
receiving, from the payment device and via a merchant terminal, payment instrument data stored in the payment device;
generating transaction data for communication to a payment network, the transaction data comprising the payment instrument data and a transaction cost;
accessing loyalty account data stored in the payment device, the loyalty account data comprising a number of loyalty account identifiers;
searching the loyalty account data for a loyalty account identifier associated with the merchant; and
identifying, from a merchant database comprising a number of loyalty accounts, a loyalty account associated with the loyalty account identifier responsive to the loyalty account identifier being found in the loyalty account data.

13. The method according to claim 12, the steps further comprising generating loyalty data based on the transaction data for updating the identified loyalty account.

14. The method according to claim 12, the steps further comprising updating the loyalty account data with a new loyalty account identifier if the loyalty account identifier is not found in the loyalty data.

15. The method according to claim 14, the steps further comprising generating a new loyalty account associated with the new loyalty account identifier.

16. The method according to claim 13, the steps further comprising updating the identified loyalty account with the loyalty data in response to successful completion of the transaction by the payment network.

17. The method according to claim 16, the steps further comprising updating the identified loyalty account with the loyalty data by accruing loyalty points on the identified loyalty account, the loyalty points being calculated based on the transaction cost.

18. The method according to claim 13, the steps further comprising updating the identified loyalty account with the loyalty data by deducting redeemed loyalty points from the identified loyalty account.

19. A consumer payment card for managing loyalty account identifiers when used in a transaction with a merchant, the payment card comprising:
a chip device configured for storing:
payment instrument data for communication to the merchant to generate transaction data and process the transaction; and
loyalty account data for access by the merchant, the loyalty account data comprising a number of loyalty account identifiers,
wherein the loyalty account data is accessible by the merchant for searching a loyalty account identifier associated with the merchant;
wherein a loyalty account of the consumer associated with the loyalty account identifier is identified by the merchant responsive to the loyalty account identifier being found in the loyalty account data; and
wherein a new loyalty account identifier is added to the loyalty account data responsive to the loyalty account identifier not being found in the loyalty account data.
